(19) United States
(12) Patent Application Publication
(10) Pub. No.: US 2024/0238157 A1
(43) Pub. Date: Jul. 18, 2024

(54) PERCUSSIVE MASSAGER WITH SMART COMFORT PULSE TECHNOLOGY MODE

(71) Applicant: MICHAEL TODD BEAUTY LP, PORT ST. LUCIE, FL (US)

(72) Inventors: MICHAEL FRIEND, PORT ST. LUCIE, FL (US); ZENG LINGZHI, WENZHOU CITY (CN)

(73) Assignee: MICHAEL TODD BEAUTY LP, PORT ST. LUCIE, FL (US)

(21) Appl. No.: 18/409,184

(22) Filed: Jan. 10, 2024

Related U.S. Application Data
(60) Provisional application No. 63/479,824, filed on Jan. 13, 2023.

(51) Int. Cl. A61H 23/00; A61H 23/02

(52) U.S. Cl. CPC A61H 23/006; A61H 23/0254; A61H 2201/0153; A61H 2201/1685

(57) ABSTRACT

A percussion massager includes a treatment head, a main housing, an electric motor structured and configured to cause the treatment head to be moved relative to the housing, and a controller provided in the main housing. The controller is structured and configured to enable the percussion massager to operate in a smart mode wherein: (i) the motor will cause the treatment head to move at a first speed that is less than an initial or user selected speed of the percussion massager responsive to no force or a force less than a threshold force being applied to the treatment head, and (ii) the motor will cause the treatment head to move at a second speed that is greater than the first speed responsive to a force exceeding the threshold being applied to the treatment head.

### CROSS REFERENCE TO RELATED APPLICATIONS

This application claims priority to U.S. Provisional Patent Application Ser. No. 63/479,824, filed on Jan. 13, 2023 and titled “Percussive Massager with Smart Comfort Pulse Technology Mode,” the disclosure of which is incorporated herein by reference.

### FIELD OF THE INVENTION

The present invention pertains to percussive massager devices, and, in particular, to a percussive massager device that has a smart comfort pulse technology mode which provides a boost of massaging power once the treatment head is pressed into the body.

### BACKGROUND OF THE INVENTION

In traditional massage therapy, a massage therapist rubs and kneads the soft tissues of the body, including muscle, connective tissue, tendons, ligaments and skin. A good massage can reduce stress, ease pain and muscle tightness, and improve circulation. Regular professional massages, however, can be time-consuming and expensive. Percussive massage guns are a popular do-it-yourself alternative to professional message therapy. A percussive massage gun is a portable, handheld device that that looks like a power drill and that is configured to deliver percussive therapy to the user. Such percussive massage guns include a head, often with interchangeable attachments, that moves quickly and forcefully to apply rapid and repetitive pressure and vibration to the soft tissue. Percussive massage guns may be especially beneficial to use after a workout or other heavy activity (e.g., work related activity) to promote recovery and to reduce muscle soreness.

### SUMMARY OF THE INVENTION

In one embodiment, a percussion massager is provided that includes a treatment head, a main housing having a handle end and an attachment end, wherein the attachment end is structured and configured to selectively and releasably hold the treatment head, an electric motor provided in the main housing, the electric motor being structured and configured to cause the treatment head to be moved relative to the housing when the treatment head is held by the attachment end, and a controller provided in the main housing. The controller is structured and configured to enable the percussion massager to operate in a smart mode wherein: (i) the motor will cause the treatment head to move at a first speed that is less than an initial or user selected speed of the percussion massager when the treatment head is held by the attachment end and responsive to no force or a force less than a threshold force being applied to the treatment head, and (ii) the motor will cause the treatment head to move at a second speed that is greater than the first speed when the treatment head is held by the attachment end and responsive to a force exceeding the threshold being applied to the treatment head.

In another embodiment, a percussion massager is provided that includes a treatment head, a main housing having a handle end and an attachment end, wherein the treatment head is coupled to the attachment end, an electric motor provided in the main housing, the electric motor being structured and configured to cause the treatment head to be moved relative to the housing, and a controller provided in the main housing. The controller is structured and configured to enable the percussion massager to operate in a smart mode wherein: (i) the motor will cause the treatment head to move at a first speed that is less than an initial or user selected speed of the percussion massager responsive to no force or a force less than a threshold force being applied to the treatment head, and (ii) the motor will cause the treatment head to move at a second speed that is greater than the first speed responsive to a force exceeding the threshold being applied to the treatment head.

In another embodiment, a method of providing percussive massage to a user is provided. The method includes powering on a percussion massager having a treatment head, holding the percussion massager and applying either no force or a force less than a threshold force to the treatment head such that the treatment head is moved at a first speed that is less than an initial or user selected speed of the percussion massager, and applying a force exceeding the threshold to the treatment head with a body part of the user, whereby responsive to the force exceeding the threshold the treatment head automatically moves at a second speed that is greater than the first speed.

### BRIEF DESCRIPTION OF THE DRAWINGS

A full understanding of the invention can be gained from the following description of the preferred embodiments when read in conjunction with the accompanying drawings in which:

FIG. 1 is a side elevational view of a battery powered and electric motor operated percussion massager 5 according to an exemplary embodiment of the disclosed concept;

FIG. 2 is a cross-sectional view of the massager of FIG. 1;

FIG. 3 is an exploded view showing an electric motor, motor shaft, and translation mechanism of the massager of FIG. 1;

FIGS. 4 and 5 are top and bottom views, respectively, of an eccentric wheel of the translation mechanism of FIG. 3;

FIGS. 6 and 7 are top and bottom views, respectively, of a connection lever and a hollow receiving shaft of the translation mechanism of FIG. 3; and

FIG. 8 is a block diagram showing a portion of the massager of FIG. 1, including a controller for controlling operation of the massager.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, the term “number” shall mean one or an integer greater than one (i.e., a plurality).

As used herein, the term “controller” shall mean a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. The memory portion can be any one or more of a variety of types of internal and/or external storage media such as, without limitation, RAM, ROM, EPROM(s), EEPROM(s), FLASH, and the like that provide a storage register, i.e., a non-transitory machine readable medium, for data and program code storage such as in the fashion of an internal storage area of a computer, and can be volatile memory or nonvolatile memory.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the disclosed concept. It will be evident, however, that the disclosed concept can be practiced without these specific details without departing from the spirit and scope of this innovation.

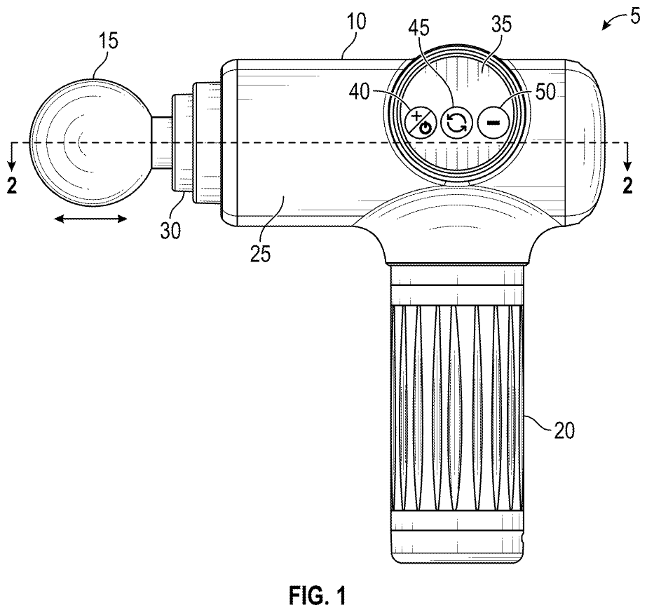

FIG. 1 is a side elevational view of a battery powered and electric motor operated percussion massager 5 according to an exemplary embodiment of the disclosed concept. Referring to FIG. 1, percussion massager 5 includes a main body portion 10 and a number of treatment heads 15 that are selectively attachable to main body portion 10. In the exemplary embodiment, the number of treatment heads include a forked treatment head, a beaded treatment head, a bullet treatment head, and a spherical treatment head (the latter being shown in FIG. 1 for illustrative purposes). Massager 5 of the disclosed concept is, as described herein, structured and configured to move the selected treatment head 15 linearly back and forth in the direction of the arrows shown in FIG. 1 in order to provide a percussive force to a selected body part of the user to massage that body part (e.g., a muscle or muscle group associated with that body part).

As seen in FIG. 1, main body portion 10 comprises a housing member having a handle end 20 structured to enable a user to grip percussion massager 5, a central portion 25, and an attachment end 30 structured to receive and releasably hold the selected treatment head 15. In addition, central portion 25 supports an input/display device 35 structured and configured to display to a user the current operational settings of massager 5 and to enable control inputs to be provided to massager 5 to change those operational settings. More specifically, in the exemplary embodiment, input/display device 35 includes a plurality of buttons 40, 45 and 50 to enable user inputs for controlling operation of percussion massager 5 as described herein. Thus, during use, a user is able to grip massager 5 at handle end 20 and apply the treatment head 15 to the body part of interest in order to provide the percussive force just described.

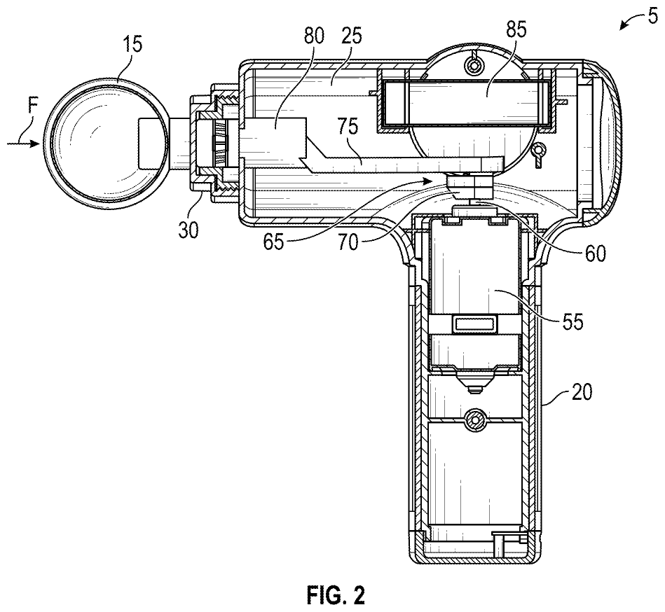

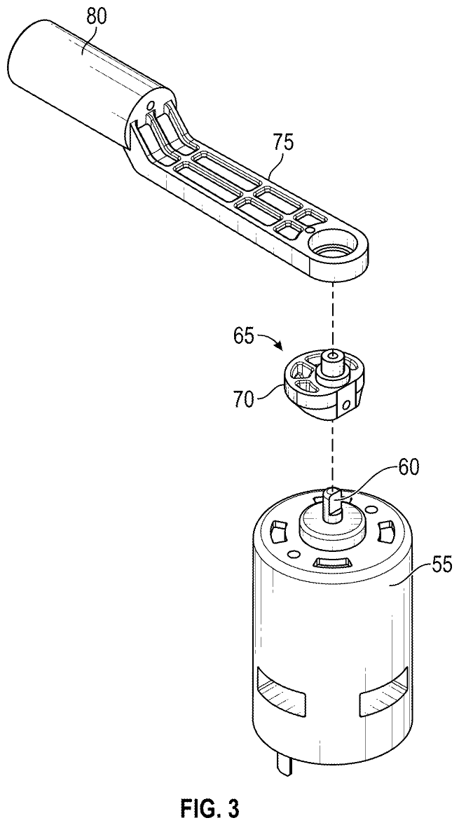

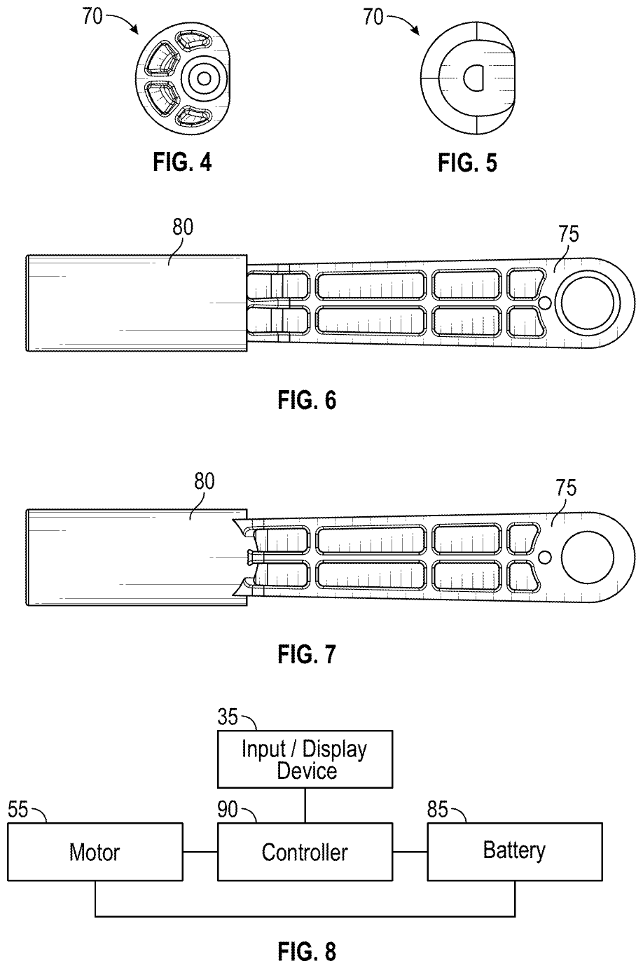

FIG. 2 is a cross-sectional view of massager 5. Referring to FIG. 2, the internal components of massager 5 will now be described. A battery-powered electric motor 55 having a motor shaft 60 is provided within handle end 20 of the housing member. Motor shaft 60 is thus structured and configured to be rotationally moved through 360° by operation of electric motor 55. In addition, a rotational to linear movement translation mechanism 65 is provided within central portion 25 of the housing member. The translation mechanism 65 includes an eccentric wheel (also referred to as an eccentric sheave) 70, a connection lever 75, and a hollow receiving shaft 80. FIG. 3 is an exploded view showing electric motor 55, motor shaft 60, and translation mechanism 65. FIGS. 4 and 5 are top and bottom views, respectively, of eccentric wheel 70, and FIGS. 6 and 7 are top and bottom views, respectively, of connection lever 75 and hollow receiving shaft 80.

As seen in FIGS. 2 and 3, eccentric wheel 70 is operatively coupled to rotatable motor shaft 60 so as to be directly coupled to the rotational movement of electric motor 55. Connection lever 75 has a proximal end that is directly coupled to a top side of eccentric wheel 70 (opposite the portion that is directly connected to shaft 60), and a distal end that is spaced from eccentric wheel 70. As seen in FIGS. 2 and 3, receiving shaft 80 is provided at the distal end of connection lever 75 and is structured to receive and hold a non-treatment end of treatment head 15. Massager 5 also includes a rechargeable battery 85 structured and configured to provide operational power to massager 5. Thus, in operation, when electric motor 55 is powered on so as to cause 360° rotation of motor shaft 60, translation mechanism 75 is structured and configured to translate that rotational energy into linear movement so as to move treatment head 15 linearly in the manner shown by the arrows in FIG. 1.

Moreover, according to a first non-limiting exemplary embodiment of the disclosed concept, massager 5 is structured and configured to be operable in two different operational modes. Those two operation modes are described below. Also, as noted below, in this first non-limiting exemplary embodiment, the first operational mode is the default operating mode for massager 5, and the second operational mode is enabled only in response to user input received via input/display device 35.

In the first operational mode (referred to herein as the non-SCPT mode), the user is able to control the speed of electric motor 55, and thus the speed of the linear movement of treatment head 15, using buttons 40 and 50 of input/display device 35. In this manner, massager 5 is structured and configured to be operated in a plurality of different operational speeds, which in the non-limiting exemplary embodiment comprise ten different speeds/levels labeled 01 (min speed—e.g., 2600 RPMs) through 10 (max speed—e.g., 3500 or 4000 RPMs). Thus, in the first operational mode (non-SCPT), the massager 5 will move the treatment head 15 linearly at the then selected speed (which may be changed by further user input) until massager 5 is shut off. In this exemplary embodiment, this non-SCPT mode is the default operating mode of massager 5, and massager 5 will operate in this mode unless and until a user input via input/display device 35 to switch to the second mode (described below) is received.

Massager 5 is also able to operate in a second operational mode, referred to herein as smart comfort pulse technology (SCPT) mode, that is different than the first operational mode (non-SCPT mode). As noted above, in this exemplary embodiment, the non-SCPT mode is the default operating mode of massager 5. Thus, when initially powered on, massager 5 will default to the first operational mode and will operate at the selected speed as determined by buttons 40 and 50. At this point, without further user input (i.e., with SCPT mode remaining off), the motor 55 will operate at the level/speed that is selected, which for illustrative purposes will be referred to herein as X RPMs (X being the rotational speed that is associated with the selected level). The user may then choose to use the device in the first operational mode as described above. However, if the user desires to operate massager 5 in the SCPT mode, the user may cause massager 5 to enter SCPT mode by depressing button 45. Immediately upon entering SCPT mode, the then selected/current speed of the device (the speed of motor 55), X RPMs, will be automatically slowed to a certain fraction or percentage, such as, without limitation, 80%, of the then selected/current speed of the device (i.e., the reduced speed, referred to herein as Z RPMs, will be equal to 0.8*X RPMs). Massager 5 is, however, further structured and configured such that if a predetermined sufficient force is then applied to the treatment head 15 in the direction of the arrow shown in FIG. 2 while massager 5 is in the SCPT mode, the speed of the treatment head 15 will be caused to be automatically increased to a speed greater than Z RPMs. For example, the increased speed may be Y*Z RPMs), wherein Y≥1 (e.g., 1.2). In an alternative implementation, the increased speed may be equal to or greater than the original speed of the selected setting (e.g., Y*X RPMs, wherein Y≥1 (e.g., 1.2)). More specifically, as will be appreciated, when the force is applied to treatment head 15 in the direction of arrow shown in FIG. 2, the force on the treatment head 15 will then apply a linear force to receiving shaft 80. Receiving shaft 80 in turn applies a linear force to connection lever 75 and to eccentric wheel 70. Responsive to his linear force, the speed of motor 55 and thus the speed of treatment head 15 will be caused to be increased as described herein. SCPT mode may be turned off by again depressing button 45, which will place massager 5 back into non-SCPT mode.

The SCPT mode as just described is advantageous as it allows massager 5 to be operated at a particular reduced speed before engaging treatment head 15 with the body of the user. The user may then engage treatment head 15 with the body at this initial lower speed (and lower force) so as to be less forceful upon initial body contact. Once sufficient force is applied to treatment head 15 as a result of treatment head 15 being applied to the selected body part, the speed of massager 5 is automatically increased as described above in order to cause additional force to be applied to the body part in question. This is beneficial as it allows the user to initially apply the treatment head 15 to a body part at a slower speed with lower percussive force, with the increased speed and higher percussive force being activated automatically upon application sufficient force to treatment head 15 by the body part. The SCPT mode may thus also be referred to as a soft start mode and/or a smart mode.

According to a second non-limiting exemplary embodiment of the disclosed concept, massager 5 is structured and configured to operate in only the SCPT mode. In other words, in this second non-limiting exemplary embodiment, the SCPT mode is the default and only operating mode of the device, and once powered on, the device will operate according to the SCPT mode as described herein.

FIG. 8 is a block diagram showing a portion of the massager of FIG. 1, including a specifically programmed controller 90 for controlling operation of massager 5 as described herein, and in particular for implementing SCPT mode as just described. More specifically, the memory portion of controller 90 has stored therein a number of routines that are executable by the processor portion of controller 90. One or more of the routines implement (by way of computer/processor executable instructions) at least one embodiment of the SCPT mode as described herein.

In the embodiments described thus far, treatment head(s) as described herein are selectively and releasably attachable to the housing at receiving shaft 80. It will be understood however, that the disclosed concept as descried herein with SCPT mode a a default and/or as a user option may also be employed in a percussive massager implementation wherein a treatment head is permanently attached to the housing.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A percussion massager, comprising:
a treatment head;
a main housing having a handle end and an attachment end, wherein the attachment end is structured and configured to selectively and releasably hold the treatment head;
an electric motor provided in the main housing, the electric motor being structured and configured to cause the treatment head to be moved relative to the housing when the treatment head is held by the attachment end; and
a controller provided in the main housing, the controller being structured and configured to enable the percussion massager to operate in a smart mode wherein: (i) the motor will cause the treatment head to move at a first speed that is less than an initial or user selected speed of the percussion massager when the treatment head is held by the attachment end and responsive to no force or a force less than a threshold force being applied to the treatment head, and (ii) the motor will cause the treatment head to move at a second speed that is greater than the first speed when the treatment head is held by the attachment end and responsive to a force exceeding the threshold being applied to the treatment head.

2. The percussion massager according to claim 1, wherein the electric motor has a rotatable shaft, wherein the percussion massager includes a translation mechanism provided in the main housing, the translation mechanism having a proximal end coupled to the shaft and distal end structured to be coupled to the treatment head when the treatment head is held at the attachment end, the translation mechanism being structured and configured to convert rotational movement of the shaft into linear movement of the treatment head when the treatment head is attached to the translation mechanism.

3. The percussion massager according to claim 2, wherein the translation mechanism includes an eccentric wheel, a connection lever, and a hollow receiving shaft, wherein the eccentric wheel is operatively coupled to the shaft so as to be coupled to the rotational movement of the shaft, wherein the connection lever has a proximal end that is coupled to a top side of the eccentric wheel, and a distal end that is spaced from the eccentric wheel, and wherein the receiving shaft is provided at a distal end of connection lever and is structured to receive and hold a non-treatment end of the treatment head.

4. The percussion massager according to claim 1, wherein the smart mode is selectable by a user of the percussion massager, and wherein the controller is structured and configured to enable the percussion massager to operate in a non-smart mode outside of the smart mode wherein the motor will cause the treatment head to move at the initial or user selected speed when the treatment head is held by the attachment end.

5. The percussion massager according to claim 4, wherein the non-smart mode is a default operating mode of the percussion massager.

6. The percussion massager according to claim 4, wherein the smart mode is a user selectable operating mode of the percussion massager.

7. The percussion massager according to claim 6, further comprising a control panel provided on the main housing, the control panel being structured and configured to display a current operating level of the percussion massager and to enable the activation of the smart mode.

8. The percussion massager according to claim 1, further comprising a plurality of different treatment heads selectively attachable to the attachment end, the treatment head and the plurality of different treatment heads including one or more of a forked treatment head, a beaded treatment head, a bullet treatment head, and a spherical treatment head.

9. The deep tissue massager according to claim 1, further comprising a rubber grip provided on the handle end.

10. A percussion massager, comprising:
a treatment head;
a main housing having a handle end and an attachment end, wherein the treatment head is coupled to the attachment end;
an electric motor provided in the main housing, the electric motor being structured and configured to cause the treatment head to be moved relative to the housing; and
a controller provided in the main housing, the controller being structured and configured to enable the percussion massager to operate in a smart mode wherein: (i) the motor will cause the treatment head to move at a first speed that is less than an initial or user selected speed of the percussion massager responsive to no force or a force less than a threshold force being applied to the treatment head, and (ii) the motor will cause the treatment head to move at a second speed that is greater than the first speed responsive to a force exceeding the threshold being applied to the treatment head.

11. The percussion massager according to claim 10, wherein the electric motor has a rotatable shaft, wherein the percussion massager includes a translation mechanism provided in the main housing, the translation mechanism having a proximal end coupled to the shaft and distal end coupled to the treatment head, the translation mechanism being structured and configured to convert rotational movement of the shaft into linear movement of the treatment head.

12. The percussion massager according to claim 11, wherein the translation mechanism includes an eccentric wheel, a connection lever, and a hollow receiving shaft, wherein the eccentric wheel is operatively coupled to the shaft so as to be coupled to the rotational movement of the shaft, wherein the connection lever has a proximal end that is coupled to a top side of the eccentric wheel, and a distal end that is spaced from the eccentric wheel, and wherein the receiving shaft is provided at a distal end of connection lever and holds a non-treatment end of the treatment head.

13. The percussion massager according to claim 11, wherein the smart mode is selectable by a user of the percussion massager, and wherein the controller is structured and configured to enable the percussion massager to operate in a non-smart mode outside of the smart mode wherein the motor will cause the treatment head to move at the initial or user selected speed.

14. The percussion massager according to claim 13, wherein the non-smart mode is a default operating mode of the percussion massager.

15. The percussion massager according to claim 13, wherein the smart mode is a user selectable operating mode of the percussion massager.

16. The percussion massager according to claim 15, further comprising a control panel provided on the main housing, the control panel being structured and configured to display a current operating level of the percussion massager and to enable the activation of the smart mode.

17. The deep tissue massager according to claim 10, further comprising a rubber grip provided on the handle end.

18. A method of providing percussive massage to a user, comprising:
powering on a percussion massager having a treatment head;
holding the percussion massager and applying either no force or a force less than a threshold force to the treatment head such that the treatment head is moved at a first speed that is less than an initial or user selected speed of the percussion massager; and
applying a force exceeding the threshold to the treatment head with a body part of the user, whereby responsive to the force exceeding the threshold the treatment head automatically moves at a second speed that is greater than the first speed.

19. The method according to claim 18, further comprising activating a smart operating mode of the percussion massager prior to the holding and applying steps, wherein a default operating mode of the percussion massager upon power up cases the treatment head to move at the initial or user selected speed.
